(19) United States
(12) Patent Application Publication
(10) Pub. No.: US 2020/0327602 A1
(43) Pub. Date: Oct. 15, 2020

(54) ARTICLE PROCESSING METHOD AND APPARATUS, AND STORAGE MEDIUM AND ELECTRONIC DEVICE

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventors: Lin LIU, Beijing (CN); Yun XIAO, Beijing (CN); Chao WANG, Beijing (CN); Shuai BI, Beijing (CN); Jie LI, Beijing (US); Li WANG, Beijing (CN); Siyuan MA, Beijing (CN); Dong LIU, Beijing (CN)

(21) Appl. No.: 16/759,345

(22) PCT Filed: Sep. 20, 2018
(86) PCT No.: PCT/CN2018/106705

§ 371 Date: Apr. 26, 2020

(30) Foreign Application Priority Data
Dec. 14, 2017 (CN) 201711338457.3

(51) Int. Cl. G06Q 30/06

(52) U.S. Cl. CPC G06Q 30/0631

(57) ABSTRACT

Provided are an article processing method and apparatus, and a storage medium and an electronic device, relating to the technical field of data processing. The article processing method comprises: determining standard size information of various articles according to a standard size mapping relationship table; collecting article purchase information of a user, and extracting standard sizes corresponding to the various articles from the article purchase information and taking same as a target standard size set; determining user preference size information from the target standard size set according to the purchase times of the various articles; and querying articles corresponding to the user preference size information and outputting same as articles to be presented, and/or preferentially presenting the articles corresponding to the user preference size information.

### CROSS-REFERENCE TO RELATED APPLICATION

This application is based upon and claims priority to PCT patent application No. PCT/CN2018/106705 filed on Sep. 20, 2018, which claims priority to Chinese Patent Application No. 201711338457.3, filed on Dec. 14, 2017 and titled as “ITEM PROCESSING METHOD AND APPARATUS, STORAGE MEDIUM AND ELECTRONIC DEVICE”, the entire contents of which are incorporated herein by reference.

### TECHNICAL FIELD

The present disclosure relates to technical field of data processing, and more particularly, to an item processing method, an item processing apparatus, a storage medium and an electronic device.

### BACKGROUND

With the rapid development of E-commerce and the widespread popularity of Mobile Internet, online shopping has been increasingly accepted by people. Especially when buying clothes, shoes and boots online, a large number of rich products, intimate user experience, and fast and convenient delivery services let more and more users to buy interesting products anytime and anywhere. However, with the sharp increase in the data of clothes, shoes, and boots on e-commerce platforms, in the face of thousands of commodities recalled by searching, users need to spend a lot of energy to select according to various conditions, so as to find a commodity that meets their needs.

At present, in some related technologies, user's global image can be obtained, and user's body image can be obtained based on the global image, a position of a preset body part can be extracted from the user's body image, user's body parameters can be calculated based on the extracted position of the preset body part, and obtain and output the user size matching the user's body parameters according to a preset database. When the user needs to buy clothes, he/she can automatically get a matched appropriate size according to the obtained user's body image.

In other related technologies, user's body information can be collected by taking into account the user's height and BMI (Body Mass Index). When the user buys clothes, she can match her body information with a recommended size, which is obtained by first determining an appropriate body shape for the user and corresponding size thereof, and then adjusting the size to suit user's body shape.

However, on the one hand, these technologies do not mention the problem of size normalization, that is to say, sizes specified by the different shops had different forms of expression for same category of commodities; on the other hand, although these related technologies can calculate the size directed to user, but whether it relies on input images or preset human body data, users need to actively implement presenting or input user data. In the e-commerce shopping environment, this kind of method not only requires additional operations by user, thus increasing the complexity of the user's shopping process, but also make users worried about privacy disclosure, so usually user is reluctant to actively fill out these private information.

In view of this, there is a need for an item processing method, an item processing apparatus, a storage medium, and an electronic equipment.

It should be noted that the information disclosed in the above background section is only for enhancing the understanding of the background of the present disclosure, and therefore may include information that does not constitute prior art known to those of ordinary skill in the art.

### SUMMARY

The purposes of the present disclosure is to provide an item processing method, an item processing apparatus, a storage medium, and an electronic equipment, thereby overcoming one or more problems caused by limitations and defects of the related art at least to a certain extent.

According to an aspect of the present disclosure, an item processing method is provided, including determining standard size information of items according to a standard size mapping relationship table; collecting item purchase information of a user, and extracting standard sizes corresponding to the items from the item purchase information as a set of target standard size; determining user preference size information from the set of target standard size according to purchase time of the items; and querying an item corresponding to the user preference size information, and outputting the item corresponding to the user preference size information as item to be presented and/or preferentially presenting the item corresponding to the user preference size information.

In an exemplary embodiment of the present disclosure, the determining user preference size information from the set of target standard size according to purchase time of the items includes: sorting the purchase time of items in reverse chronological order; configuring weights for respective target standard sizes according to result sorted by the reverse chronological order; and determining user preference size information based on the configured weights.

In an exemplary embodiment of the present disclosure, the configuring weights for respective target standard sizes according to result sorted by the reverse chronological order includes configuring weights for respective target standard sizes according to result sorted by the reverse chronological order in an exponential decay manner.

In an exemplary embodiment of the present disclosure, the determining user preference size information based on the configured weights includes calculating preference probabilities of information about respective target standard sizes based on the configured weights; if a difference between a highest probability and a second-highest probability in calculated preference probabilities is greater than a threshold, determining the information of target standard size corresponding to the highest probability as the user preference size information; and if the difference between the highest probability and the second-highest probability in calculated preference probabilities is not greater than the threshold, determining the information of target standard size corresponding to the highest probability and the information of target standard size corresponding to the second-highest probability as user preference size information.

In an exemplary embodiment of the present disclosure, the preferentially presenting the items corresponding to the user preference size information includes: if size information of an candidate item matches the user preference size information, configuring weight for the candidate item; and determining the candidate item having configured weight as the item to be presented preferentially and presenting it.

In an exemplary embodiment of the present disclosure, after determining standard size information of items according to the standard size mapping relationship table, the item processing method further includes storing the standard size information into a forward index of corresponding one of the items.

According to an aspect of the present disclosure, an item processing apparatus is provided, including: a standard size determination module, configured to determine standard size information of items according to a standard size mapping relationship table; a target standard size extraction module, configured to collect item purchase information of a user, and extract standard sizes corresponding to the items from the item purchase information as a set of target standard size; a preference size determination module, configured to determine user preference size information from the set of target standard size according to purchase time of the items; and an item presentation module, configured to query an item corresponding to the user preference size information, and outputting the item corresponding to the user preference size information as item to be presented and/or preferentially presenting the item corresponding to the user preference size information.

In an exemplary embodiment of the present disclosure, the preference size determination module includes: a sorting sub-module, configured to sort the purchase time of items in reverse chronological order; a weight configuration sub-module, configured to configure weights for respective target standard sizes according to result sorted by the reverse chronological order; and a preference size determination sub-module, configured to determine user preference size information based on the configured weights.

In an exemplary embodiment of the present disclosure, the weight configuration sub-module includes a weight configuration unit, configured to configure weights for respective target standard sizes according to result sorted by the reverse chronological order in an exponential decay manner.

In an exemplary embodiment of the present disclosure, the preference size determination sub-module includes: a preference probability calculation unit, configured to calculate preference probabilities of information about respective target standard sizes based on the configured weights; a first preference size determination unit, configured to determine the information about target standard size corresponding to the highest probability as the user preference size information, if a difference between a highest probability and a second-highest probability in calculated preference probabilities is greater than a threshold; and a second preference size determination unit, configured to determine the information about target standard size corresponding to the highest probability and the information about target standard size corresponding to the second-highest probability as user preference size information, if the difference between the highest probability and the second-highest probability in calculated preference probabilities is not greater than the threshold.

In an exemplary embodiment of the present disclosure, the item presentation module includes an item weight configuration sub-module, configured to configure weight for an candidate item; if size information of the candidate item matches the user preference size information; and an item presentation sub-module, configured to determine the candidate item having configured weight as the item to be presented preferentially and present it.

In an exemplary embodiment of the present disclosure; the item processing apparatus further includes a standard size storage module, configured to store the standard size information into a forward index of corresponding one of the items.

According to an aspect of the present disclosure, a storage medium is provided, which having computer instructions stored thereon, when the computer instructions are executed by a processor, any one of the item processing methods described above is implemented.

According to an aspect of the present disclosure, an electronic equipment is provided, including: a processor; and a memory for storing instructions executable by the processor; wherein the processor is configured to implement any one of the item processing methods described above via the execution of executable instructions.

In the technical solutions provided by some embodiments of the present disclosure, standard size information of items is determined by a standard size mapping relationship table, user preference size information is determined, and one or more corresponding items are presented to the user based on the user preference size information. On the one hand, a way for describing the size can be unified by determining the standard size information for one or more items, which makes interface for searching and selecting more concise while being easier to search; on the other hand, one or more items to be presented to user are determined based on the user's preferred size information, and in cases where the user does not need to select in the searching scenario, one or more items meeting user's size can be automatically presented to user first, so that the user can find one or more items that meet his needs more quickly. Moreover, in addition to the user actively searching for item, in the field of recommending advertising, according to the user's preferred size information, one or more items that meet the user's size are accurately recommended to user and presented, which can improve the user experience and precisely allocate traffic.

It is to be understood that the above general description and the detailed description below are merely exemplary and explanatory, and do not limit the present disclosure.

### BRIEF′ DESCRIPTION OF THE DRAWINGS

The accompanying drawings, which are incorporated in the specification and constitute a part of the specification, show the embodiments in compliance with the present disclosure, and are used to interpret the principle of the present disclosure together with the description. It is apparent that the drawings in the following description are only some embodiments of the present disclosure, from which, other drawings may be acquired by those ordinary skilled in the art without paying any creative labor. In the drawings:

FIG. 1 schematically shows a flowchart of an item processing method according to an exemplary embodiment of the present disclosure;

FIG. 2 shows a schematic diagram of a data organization form for presenting commodities according to an exemplary embodiment of the present disclosure;

FIG. 3 schematically shows a flowchart of sorting commodities according to an exemplary embodiment of the present disclosure;

FIG. 4 schematically shows a block diagram of an item processing apparatus according to an exemplary embodiment of the present disclosure;

FIG. 5 schematically shows a block diagram of a preference size determination module according to an exemplary embodiment of the present disclosure;

FIG. 6 schematically shows a block diagram of a weight configuration sub-module according to an exemplary embodiment of the present disclosure;

FIG. 7 schematically shows a block diagram of a preference size determination sub-module according to an exemplary embodiment of the present disclosure;

FIG. 8 schematically shows a block diagram of an item presenting module according to an exemplary embodiment of the present disclosure;

FIG. 9 schematically shows another block diagram of an item processing apparatus according to an exemplary embodiment of the present disclosure;

FIG. 10 shows a schematic diagram of a storage medium according to an exemplary embodiment of the present disclosure; and

FIG. 11 schematically shows a block diagram of an electronic device according to an exemplary embodiment of the present disclosure.

### DETAILED DESCRIPTION

Exemplary embodiments will now be described more fully with reference to the accompanying drawings. However, the exemplary embodiments may be embodied in many forms and should not be construed as limited to the examples set forth herein; rather, these embodiments are provided so that this disclosure will be more thorough and complete, and will fully convey the concept of the exemplary embodiments to those skilled in the art. Furthermore, the described features, structures, or characteristics may be combined in any suitable manner in one or more embodiments. In the following description, numerous specific details are given to provide a thorough understanding of embodiments of the present disclosure. Those skilled in the art will realize that the technical solutions of the present disclosure may be practiced without one or more of the specific details, or other methods, components, apparatus, steps, etc. may be utilized. In other instances, well-known technical solutions are not shown or described in detail to avoid obscuring respective aspects of the present disclosure.

In addition, the drawings are merely schematic representations of the present disclosure and are not necessarily drawn to scale. The same reference numerals in the drawings represent the same or similar parts, so the repeated description thereof will be omitted. Some of the block diagrams shown in the accompanying drawings are functional entities and do not necessarily correspond to physically or logically separate entities. These functional entities may be implemented in software form, or in one or more hardware modules or integrated circuits, or implemented in different networks and/or processor devices and/or microcontroller devices.

The flowchart shown in the drawings is only an exemplary description and does not necessarily include all steps. For example, some steps can also be decomposed, and some steps can be merged or partially merged, so the actual execution order may change according to the actual situation.

In the following description of item processing method and apparatus of the present disclosure, an item may be a commodity that can be purchased by a user through an e-commerce platform for example. Specifically, the item processing method and apparatus of the present disclosure will be described below taking the size of clothes, shoes and boots as an example. However, it should be understood that the concept of the present invention can also be applied to search or recommendation scenarios other than item size, for example, the schemes of recommending items to users according to item specifications, item prices, etc. can also be implemented using the concept of the present disclosure.

Take the user searching for loose pants' as an example to explain some of the current search situations. When user enter ‘loose pants’ in a search bar on the e-commerce platform, she often recalls tens of thousands of commodities. The term ‘recall’ mentioned here means that in a search system, after a keyword to be searched is divided into phrases, get the commodities corresponding to each phrase and find the intersection of these commodities. However, the top commodities displayed on the interface may not have size preferred by user, resulting in the user not being able to find the commodity that she is satisfied with within a short period of time, which may cause serious problems for the loss of some users. For some patient users, they will find a filter box on the interface and filter out the commodities having their size, such as ‘XS’, from the displayed commodities. However, since the sizes labeled by the shops are not uniform, for example, commodities of certain shops are labeled by numbers, such as ‘25’, ‘26’, etc., and commodities of other shops are labeled by letters, such as ‘XS’, ‘XXS’, etc., when an keyword selected by the user is ‘XXS’, the user can only see the commodities corresponding to ‘XXS’. In case of size ‘XXS’ corresponds to size ‘25’, this may cause the commodities with size ‘25’ cannot to be recalled, however there may has the commodities that the user likes in these unrecalled commodities. In addition, some current related technologies have the problem of failing to recommend commodities to users based on the user's preferred size.

In view of this, the present disclosure provides an item processing method and an item processing apparatus.

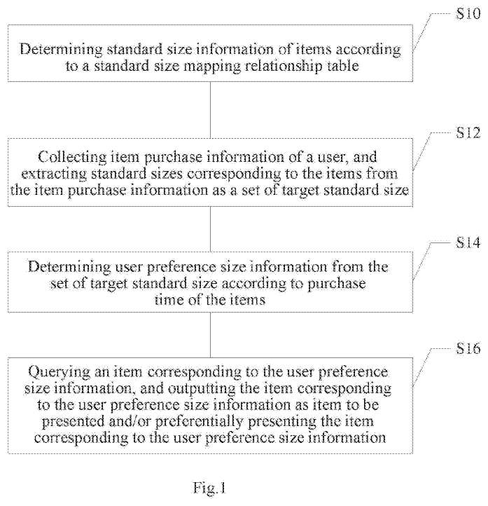

FIG. 1 schematically shows a flowchart of an item processing method of an exemplary embodiment of the present disclosure. Referring to FIG. 1, the item processing method may include the following steps.

In step S10, standard size information of various items is determined according to a standard size mapping relationship table.

Due to the different manufacturers, sellers or operators of the items, size of the same item may be given different measurement ways. For example, for an item with a specific shape, when length is used as one of the measurement standards for size, in some cases, the length may be measured in meters, or in other cases, the length may be measured in inches. In view of this, in order to unify the way to describe the size, first the present disclosure needs to configure a standard size mapping relationship table of items. Specifically, the standard size mapping relationship table can be constructed by comprehensively considering factors such as user habits, current standards, and degree of brief representation. Next, standard size information of one or more items can be determined according to the standard size mapping relationship table.

Take an example that an item is a commodity that user can purchase through the e-commerce platform. In this case, an item can be divided according to category. For example, commodities such as clothes, shoes and boots can be divided into Underwear/Clothing for Women, Underwear/Clothing for Men, Sports Outdoor/Shoes and Bags for Sports, Sports Outdoor/Sportswear, Sports Outdoor/Clothes and Shoes for Outdoor, Maternal and Infant Supplies/Clothes and Shoes for Children, as well as Shoes and Boots, etc.

First, a standard size mapping relationship table can be established by mining and analyzing the fields, such as name, attribute, size, and so on of the commodities, and combining artificial experience. Specifically, for different categories of commodities, using same size to represent different meanings. For example, in terms of size ‘L’, the size ‘L’ for Men's clothing is different from the size ‘L’ for Women's Clothing. For another example, size ‘36’ may represent the size ‘36’ of shoes, or it may represent the size ‘36’ of pants. Therefore, when representing the user's size, it is obviously unclear to list only size. In this case, when describing size, a specific category needs to be given, for example, {User: a, Category: Men's Pants, Size: 36}.

For example, commodities about clothes, shoes and boots can be divided into 8 size class, namely: Men's Tops/cloth_m, Men's Pants/pants_m, Women's Tops (Presses)/cloth_f, Women's Pants (Skirts)/pants_f, Wen's Shoes/shoe_m, Women's Shoes/shoe_f, Children's Clothes/cloth_c, Children's Shoes/shoe_c. Based on this, the standard size mapping relationship table can be constructed. Table 1 exemplarily shows a part of the standard size mapping relationship table.

TABLE 1

| | Standard | Size which may appear in the names or attributes |
|---|---|---|
| Category | size | of commodity |
| cloth_m | L | large size, big size, L, 50, 175/88A, 175/92A, 175 |
| cloth_m | M | medium size, medium, M, 48, 170/84A, 170/88A, |
| | | 170 |
| cloth_m | S | small size, little size, S, 46, 165/80A, 165/84A, |
| | | 165 |
| cloth_m | XL | plus L, plus L size, plusL, big plus, big plus size, |
| | | bigplus, XL, 52, 180/92A, 180/100A, 180 |
| cloth_m | XS | plus S, plus S size, plusS, XS |
| cloth_m | XXL | super-size, super-large, 2XL, XXL, 54, 185/96A, |
| | | 185/112B, 185 |
| cloth_m | XXS | extra small-size, extra small, 2XS, XXS |
| cloth_m | 3XL | XXXL, 3XL, 56, 190/100A, 190/100A, 190 |
| cloth_m | 3XS | XXXS, 3XS |
| cloth_m | 4XL | XXXXL, 4XL, 195 |
| cloth_m | 5XL | XXXXXL, 5XL |
| cloth_m | 6XL | XXXXXXL, 6XL |
| cloth_m | 7XL | XXXXXXXL, 7XL |
| cloth_m | 8XL | XXXXXXXXL, 8XL |
| cloth_f | L | large size, big size, L, 170, 100/170, 105/170, |
| | | 110/170, 42,170/92A, size 4 |
| cloth_f | M | medium size, medium, M, 165, 100/165, 105/165, |
| | | 40, 165/88A, size 3 |
| cloth_f | S | small size, little size, S, 160, 38, 160/84A, size 2 |
| cloth_f | XL | plus L, plus L size, plusL, big plus, big plus size, |
| | | bigplus, 1XL, XL, 175, 105/175, 110/175, 115/ |
| | | 175, 44, size 5 |
| cloth_f | XS | plus S, plus S size, plusS, XS, 155, 36, 155/68A, |
| | | size 1 |
| cloth_f | XXL | super-size, super-large, 2XL, XXL, 180, 110/180, |
| | | 115/180, 120/180, 46, size 6 |
| cloth_f | XXS | extra small-size, extra small, 2XS, XXS, 150, |
| | | size 0 |
| cloth_f | 3XL | XXXL, 3XL, 185, 120/185, 125/185, 48, size 7 |
| cloth_f | 3XS | XXXS, 3XS |
| cloth_f | 4XL | XXXXL, 4XL, 190 |
| cloth_f | 5XL | XXXXXL, 5XL, 195 |
| cloth_f | 6XL | XXXXXXL, 6XL |
| cloth_f | 7XL | XXXXXXXL, 7XL |
| cloth_f | 8XL | XXXXXXXXL, 8XL |
| pants_m | 27 | 27, XS, 160/66A, 160, 165 |
| pants_m | 28 | 28, 160/70A |
| pants_m | 29 | 29, S, 170/72A, 2.2 feet, two and a fifth feet, 170 |
| pants_m | 30 | 30, 170/74A, 2.3 feet, two and three tenths feet |

Next, standard sizes of one or more items are determined according to the standard size mapping relationship table. For example, size ‘175’ for Men's Tops can be mapped to of standard size, size ‘S’ for Women's Pants can be mapped to ‘27’ of standard size, size ‘155/68A’ for Women's Tops can be mapped to ‘XS’ of standard size, and so on.

In addition, standard sizes determined for respective commodities can be stored in a forward index of the corresponding commodity. Taking the standard size ‘L’ mapped from Men's Tops as an example, ‘L’ can be stored in the forward index corresponding to Men's Tops. The expression of ‘forward index’ may refer to an index where attributes corresponding to a commodity are stored, and the attributes may include but not limited to name, price, size, sales volume, etc. The standard size can be stored in the forward index, which is helpful for searching commodities. In addition, it should be understood that information of the commodity and the standard size corresponding to said commodity may also be stored in another storage space in a pair, which is not specifically limited in this disclosure.

In step S12, item purchase information of a user is collected and standard sizes corresponding to one or more items is extracted from the item purchase information to treat as a set of target standard size, wherein the item purchase information is the information about one or more items purchased by user.

It is easy to understand that every time a user purchases an item, a server can store information of the item purchased by the user at this time in a storage space corresponding to the user account. The item information may include, but is not limited to, type, color, size, purchase time, price, discount and other information of the item.

First, the server can collect the information of one or more items purchased by the user from the storage space where historical purchase records are stored; next, the server can extract the standard sizes corresponding to respective items from the information of the purchased items, and these standard sizes can form the set of target standard size.

In step S14, user preference size information is determined from the set of target standard size according to the purchase time of one or more items.

First, the one or more items purchased by the user can be sorted in reverse chronological order, and thus chronological order of target standard sizes corresponding to the purchased items can be obtained. The reverse chronological order means starting from the most recent purchase and ending with the earliest purchase which may be the first purchase. For example, the reverse chronological order may be arranged as the most recent purchase on top and the first purchase on bottom.

Next, weights can be configured for the target standard sizes in chronological order. Specifically, the target standard sizes may be weighted in an exponential decay manner, and the base of the corresponding exponential decay function may be 0.8, for example. However, it should be understood that 0.8 is treated as the base is only an example of the present disclosure. In addition, developers can also re-determine the base according to factors such as the e-commerce operation status, the duration of hot seller, and so on. In this exemplary embodiment, a value of the base corresponding to the exponential decay function is not particularly limited.

For example, taking user's purchase for men's tops as an example, user's purchase history records shows that men's tops are purchased five times. The target standard sizes corresponding to men's tops purchased in reverse chronological order can be L, L, L M and S. Next, corresponding weights can be configured for these five target standard sizes, for example, the weights can be 10, 8, 7, 1, 0.2, respectively.

Subsequently, user preference size information may be determined according to the configured weights. Specifically, preference probabilities of respective target standard size information can be calculated based on the configured weights. If a difference between a highest probability and a second-highest probability in the calculated preference probabilities is greater than a threshold, the target standard size information corresponding to the highest probability is determined as the user preference size information; and if the difference between the highest probability and the second-highest probability in the calculated preference probabilities is not greater than the threshold, the target standard size information corresponding to the highest probability and the target standard size information corresponding to the second-highest probability are determined as user preference size information. The threshold may be 0.7, for example. However, it should be understood that 0.7 is only an example, and the developer may also re-determine the threshold according to other factors.

Still taking the above-mentioned user's purchase for men's tops as an example, the types of target standard size may be L, M, and S. The preference probability for the target standard size ‘L’ may be about 0.95, the preference probability for the target standard size ‘M’ may be about 0.04, and the preference probability for the target standard size ‘S’ may be about 0.01. Among them, the highest probability is 0.95, the second-highest probability is 0.04, and the difference between them is greater than the threshold 0.7, then size ‘L’ can be used as the user's preferred size when he buys men's tops.

In another embodiment, in the case of the target standard sizes corresponding to the men's tops purchased by another user are L, L, L, M, and S, respectively, and the purchase time of the user are different from the purchase time of the user mentioned above, thus the configured weights may be 20, 15, 14, 10, 1, respectively, then the preference probability for the target standard size ‘L’ can be about 0.82, the preference probability for the target standard size ‘M’ can be about 0.17, and the preference probability for the target standard size ‘S’ can be about 0.01. Among them, the highest probability is 0.82, the second-highest probability is 0.17, and the difference between them is less than the threshold 0.7, then both size ‘L’ and ‘M’ can be used as the user's preferred size when he buys men's tops.

The user's preferred size can be obtained by the process above, and an example code description will be given below.

```
userSize {
  uid: “jd_6cc9c60ed7cd7”
  cloth_m {
    size: “L”
probability: 1.0
  }
pants_m {
    size: “33”
probability: 1.0
  }
shoe_m {
    size: “42”
probability: 1.0
  }
}
```

In step S16, one or more items corresponding to the user preference size information are queried, and the one or more items corresponding to the user preference size information are output as items to be presented and/or the one or more items corresponding to the user preference size information are presented preferentially.

According to some embodiments of the present disclosure, one or more items corresponding to the user preference size may be provided to the user as presented items.

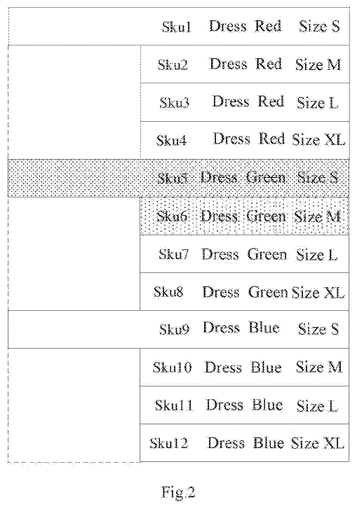

At present, in order to reduce the number of items being indexed, a method of de-duplicating is adopted for items of the same color and different sizes to retain one item, and finally only one or more main items having different colors are displayed on the interface of search result. In terms of storage structure, in order to improve the efficiency of querying a specified size of item, these items are stored according to size from small to big, so that a search method such as dichotomy method can be used for quick query. Referring to FIG. 2, it is assumed that with the search term of ‘Dress’, a total of 12 commodities for Dress from Sku1 to Sku12 should be indexed, and the three commodities of Sku1, Sku5, and Sku9 are actually indexed after the same color de-duplication, and since these three commodities are different with each other only in color, so they will be merged into a single commodity on the interface of search result. The specific algorithm for merging is to select a commodity with the highest sales among the three commodities as a main commodity. For example, the commodity presented finally is Sku5.

However, if determined user preference size is size ‘M’ in step S14, the search system can adjust the commodity Sku6 having size ‘M’ as the main commodity and present it on the interface of search results preferentially. User can see the commodity that meets size thereof in the first place, thus avoiding the process of size selection between the search result interface and single product presentation interface.

According to other embodiments, one or more items corresponding to the user preference size information may be preferentially presented. Since a huge number of commodities are recalled by user per search, but the user's attention is often focused on the first few commodities. Therefore, the commodities that meet the user's preferred size can also be sorted in advance, so that users can quickly find these commodities.

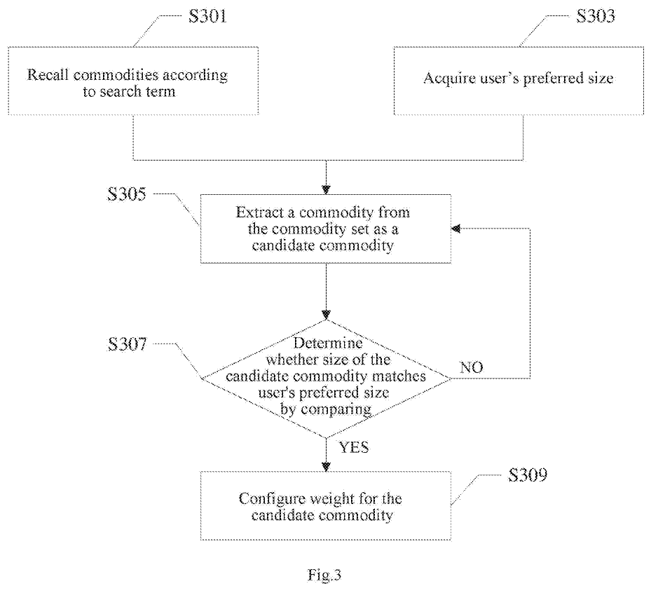

Referring to FIG. 3, in step S301, the user can input a search term to recall one or more commodities; in step S303, the server can acquire user preference size information; in step S305, a commodity can be extract from a set of recalled commodities as a candidate commodity; In step S307, it is determined whether the size of the candidate commodity matches the user's preferred size by comparing. If the size of the candidate commodity matches the user's preferred size, the step goes to step S309, and if the size of the candidate commodity does not match the user's preferred size, the step goes to step S305; in step S309, a weight can be configured for the candidate commodity. In addition, the candidate commodity with matching weight may be determined as a commodity to be presented preferentially and presented it to the user.

One or more commodities meeting the user's size are presented preferentially by the above sorting process, so that the user can quickly find the commodities that meet the demand.

In the item processing method of the present disclosure, standard size information of items is determined by a standard size mapping relationship table, user preference size information is determined, and one or more corresponding items are presented to the user based on the user preference size information. On the one hand, a way for describing the size can be unified by determining the standard size information for one or more items, which makes interface for searching and selecting more concise while being easier to search; on the other hand, one or more items to be presented to user are determined based on the user's preferred size information, and in cases where the user does not need to select in the searching scenario, one or more items meeting user's size can be automatically presented to user first, so that the user can find one or more items that meet his needs more quickly. Moreover, in addition to the user actively searching for item, in the field of recommending advertising, according to the user's preferred size information, one or more items that meet the user's size are accurately recommended to user and presented, which can improve the user experience and precisely allocate traffic.

It should be noted that although various steps of the method in the present disclosure are described in a specific order in the drawings, this does not require or imply that the steps must be performed in the specific order, or all the steps shown must be performed to achieve the desired result. Additionally or alternatively, some steps may be omitted, multiple steps may be combined into one execution step, and/or one step may be decomposed into multiple execution steps, and so on.

Furthermore, in this example embodiment, an item processing apparatus is also provided.

FIG. 4 schematically shows a block diagram of an item processing apparatus of the exemplary embodiment of the present disclosure. Referring to FIG. 4, an item processing apparatus 4 according to the exemplary embodiment of the present disclosure may include a standard size determination module 41, a target standard size extraction module 43, a preference size determination module 45, and an item presentation module 47.

The standard size determination module 41 may be used to determine standard size information of one or more items according to a standard size mapping relationship table.

The target standard size extraction module 43 may be used to collect item purchase information of user, and extract standard sizes corresponding to the items from the item purchase information as a set of target standard size, wherein the item purchase information is the information about one or more items purchased by user.

The preference size determination module 45 may be used to determine information about user's preferred size from the set of target standard size according to purchase time of the one or more items.

The item presentation module 47 may be used to query one or more items corresponding to the information about user preference size, and output the one or more items corresponding to the user preference size information as items to be presented and/or preferentially present the one or more items corresponding to the information about user preference size.

In the item processing apparatus of the present disclosure, on the one hand, a way for describing the size can be unified by determining the standard size information for one or more items, which makes interface for searching and selecting more concise while being easier to search; on the other hand, one or more items to be presented to user are determined based on the user preference size information, and in cases where the user does not need to select in the searching scenario, one or more items meeting user's size can be automatically presented to user first, so that the user can find one or more items that meet his needs more quickly. Moreover, in addition to the user actively searching for item, in the field of recommending advertising, according to the user preference size information, one or more items that meet the user's size are accurately recommended to user and presented, which can improve the user experience and precisely allocate traffic.

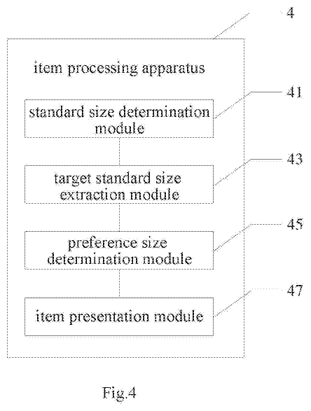

According to an exemplary embodiment of the present disclosure; referring to FIG. 5, the preference size determination module 45 may include a sorting sub-module 501, a weight configuration sub-module 503 and a preference size determination sub-module 505.

The sorting sub-module 501 may be used to sort the purchase time of one or more items in reverse chronological order. The reverse chronological order means starting from the most recent purchase and ending with the earliest purchase which may be the first purchase. For example, the reverse chronological order may be arranged as the most recent purchase on top and the first purchase on bottom.

The weight configuration sub-module 503 may be used to configure corresponding weights for respective target standard sizes in the set of target standard size according to result sorted by reverse chronological order.

The preference size determination sub-module 505 may be used to determine user's preferred size information based on the configured weights.

In this embodiment, a weight is configured for the target standard size based on time, which reflects the change of the user's purchase demand, so that the determined preference size of user is closer to the actual demand of the user.

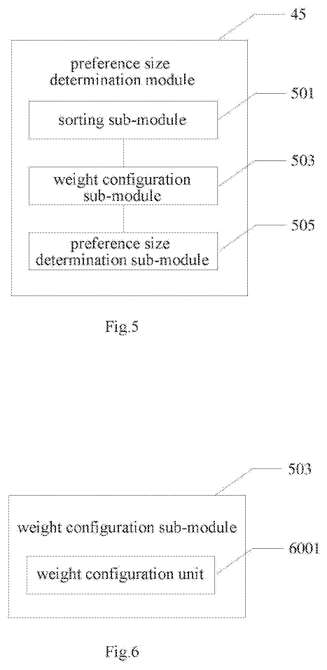

According to an exemplary embodiment of the present disclosure, referring to FIG. 6, the weight configuration sub-module 503 may include a weight configuration unit 6001.

The weight configuration unit 6001 may be used to configure corresponding weights for respective target standard sizes in the set of target standard size according to result sorted by reverse chronological order in an exponential decay manner.

In this embodiment, the weight is configured in an exponentially decaying manner, which reflects the weight of the target standard size more reasonably. In addition, the base can be modified to meet weight configuration of different actual situations.

According to an exemplary embodiment of the present disclosure, referring to FIG. 7, the preference size determination sub-module 505 may include a preference probability calculation unit 7001, a first preference size determination unit 7003, and a second preference size determination unit 7005.

The preference probability calculation unit 7001 may be used to calculate preference probabilities of information about respective target standard sizes based on the configured weights.

The first preference size determination unit 7003 may be used to determine the information of target standard size corresponding to highest probability as the user's preferred size information, if difference between highest probability and second-highest probability in the calculated preference probabilities is greater than a threshold.

The second preference size determination unit 7005 may be used to determine the information of target standard size corresponding to highest probability and the information of target standard size corresponding to second-highest probability as the user's preferred size information, if difference between highest probability and second-highest probability in the calculated preference probabilities is not greater than the threshold.

In this embodiment, the user's preferred size is determined by calculating preference probabilities of respective target standard sizes and analyzing the preference probabilities. The determined preference size of user is closer to the actual needs of the user by setting the threshold.

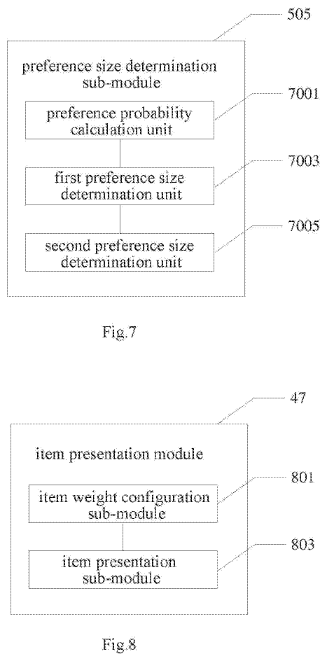

According to an exemplary embodiment of the present disclosure, referring to FIG. 8, the item presentation module 47 may include an item weight configuration sub-module 801 and an item presentation sub-module 803.

The item weight configuration sub-module 801 may be used to configure weight for an candidate item, if the size information of the candidate item matches the user preference size information:

The item presentation sub-module 803 may be used to determine the candidate item configured with weight as an item to be presented preferentially and present it.

One or more commodities that match the user's preferred size can be presented preferentially, so that user can quickly view commodities that meet his needs.

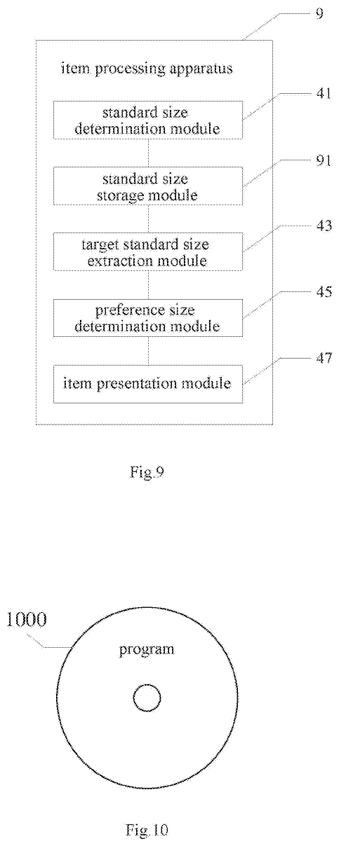

According to an exemplary embodiment of the present disclosure, referring to FIG. 9, compared to the item processing apparatus 4, in addition to a standard size determination module 41, a target standard size extraction module 43, a preference size determination module 45, and an item presentation module 47, the item processing apparatus 9 further includes a standard size storage module 91.

The standard size storage module 91 may be used to store the standard size information into a forward index of the corresponding item in the items.

In this embodiment, storing the standard size into the forward index of the corresponding commodity is helpful for searching.

Since function modules of the program running performance analysis device according to the embodiment of the present disclosure are the same as that in the above-mentioned method embodiment, it will not be repeated here.

In an exemplary embodiment of the present disclosure, there is also provided a computer-readable storage medium on which a program product capable of implementing the above method of the disclosure is stored. In some possible implementation manners, various aspects of the present disclosure may also be implemented in the form of a program product, including program code which, when being executed by a terminal device, causes the terminal device to implement steps of various exemplary embodiments described in the forgoing “detailed description” part of the specification.

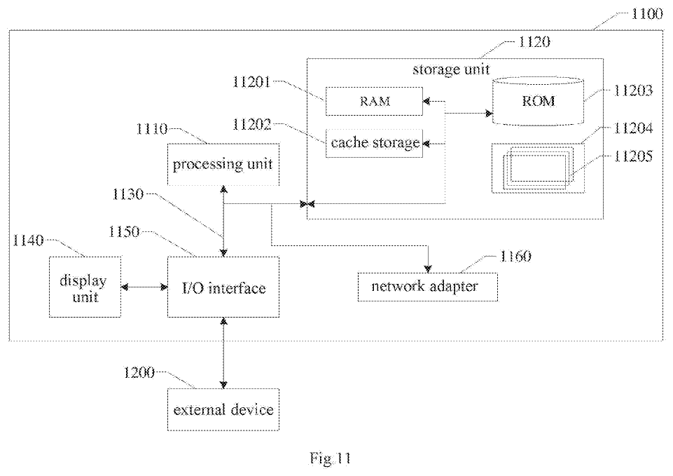

Referring to FIG. 10, a program product 1000 for implementing the above method according to an embodiment of the present disclosure is described. It may be implemented using a portable compact disk read-only memory (CD-ROM) and include a program code, and may be executed by a terminal device, for example, a personal computer. However, the program product of the present disclosure is not limited thereto. In the disclosure, the readable storage medium may be any tangible medium containing or storing a program, which may be used by or in combination with an instruction execution system, apparatus, or device.

The program product may employ any combination of one or more readable medium. The readable medium may be a readable signal medium or a readable storage medium. The readable storage medium may be, for example but not limited to, an electrical, magnetic, optical, electromagnetic, infrared, or semiconductor system, apparatus, or device, or any combination thereof. More specific examples of readable storage medium (non-exhaustive list) may include: electrical connections with one or more wires, portable disks, hard disks, random access memory (RAM), read only memory (ROM), erasable programmable read-only memory (EPROM or flash memory), optical fiber, portable compact disk read-only memory (CD-ROM), optical storage device, magnetic storage device, or any suitable combination of the foregoing.

The computer-readable signal medium may include a data signal that is transmitted in baseband or as part of a carrier wave, in which readable program code is carried. This transmitted data signal can take many forms, including but not limited to electromagnetic signals, optical signals, or any suitable combination of the above. The readable signal medium may also be any readable medium other than a readable storage medium, and the readable medium may send, propagate, or transmit a program for use by or in combination with an instruction execution system, apparatus, or device.

The program code contained on the readable medium may be transmitted using any appropriate medium, including but not limited to wireless, wired, optical fiber cable, RF, etc., or any suitable combination of the foregoing.

The program code for performing the operations of the present disclosure may be written in any combination of one or more programming languages, which may include an object oriented programming language, such as the Java and C++, or may include conventional formula programming language, such as “C” language or similar programming language. The program code may be entirely executed on the user computing device, partly executed on the user device, executed as an independent software package, partly executed on the user computing device and partly executed on a remote computing device, or entirely executed on the remote computing device or server. In situations involving a remote computing device, the remote computing device may be connected to the user computing device through any kind of network, including a local area network (LAN) or a wide area network (WAN), or may be connected to an external computing device e.g., through connection via the Internet using Internet service provider).

In an exemplary embodiment of the present disclosure, there is also provided an electronic equipment capable of implementing the above method.

Those skilled in the art can understand that various aspects of the present disclosure can be implemented as a system, a method, or program product. Therefore, various aspects of the present disclosure may be specifically implemented in the form of: a complete hardware implementation, a complete software implementation (including firmware, microcode, etc.), or a combination of hardware and software implementations, which may be collectively referred to herein as “circuit”, “module” or “system”.

The electronic device 1100 according to this embodiment of the present disclosure will be described below with reference to FIG. 11. The electronic device 1100 shown in FIG. 11 is only an example, and should not imply any limitation to the functions and usage scope of the embodiments of the present disclosure.

As shown in FIG. 11, the electronic device 1100 is represented in the form of a general-purpose computing device. The components of the electronic device 1100 may include, but are not limited to: at least one processing unit 1110, at least one storage unit 1120, a bus 1130 connecting different system components (including the storage unit 1120 and the processing unit 1110), and display unit 1140.

In an embodiment, the storage unit stores program codes which, when being executed by the processing unit 1110, causes the processing unit 1110 to implement steps of various exemplary embodiments described in the forgoing “detailed description” part of the specification. For example, the processing unit 1110 may be configured to perform, as shown in FIG. 1, step S10, determining standard size information of items according to a standard size mapping relationship table; step S12, collecting item purchase information of a user, and extracting standard sizes corresponding to the items from the item purchase information as a set of target standard size; step S14, determining user preference size information from the set of target standard size according to purchase time of the items; and step S16, querying an item corresponding to the user preference size information, and outputting the item corresponding to the user preference size information as item to be presented and/or preferentially presenting the item corresponding to the user preference size information.

The storage unit 1120 may include a readable medium in the form of a transitory storage unit, such as a random access storage unit (RAM) 11201 and/or a high-speed cache storage unit 11202, and may further include a read-only storage unit (ROM) 11203.

The storage unit 1120 may further include a program/utility tool 11204 having a set of (at least one) program module 11205. Such program module 11205 includes, but not limited to, an operating system, one or more application programs, other program modules, and program data. Each of these examples or some combination thereof may include an implementation of network environment.

The bus 1130 may be one or more of several types of bus structures, including a storage unit bus or a storage unit controller, a peripheral bus, a graphics acceleration port, a processing unit, or a local area using any of a variety of bus structures bus.

The electronic device 1100 may also communicate with one or more external devices 1200 (e.g., keyboard, pointing device, Bluetooth device, etc.), and may also communicate with one or more devices that enable a user to interact with the electronic device 1100, and/or any device (e.g., router, modem, etc.) that enables the electronic device 1100 to communicate with one or more other computing devices. This communication can be performed through an input/output (I/O) interface 1150. Moreover, the electronic device 1100 can also communicate with one or more networks (e.g., local area network (LAN), a wide area network (WAN), and/or a public network such as the Internet) through a network adapter 1160. As shown in the drawing, the network adapter 1160 communicates with other modules of the electronic device 1100 through the bus 1130. It should be understood that, although not shown in the drawing, other hardware and/or software modules may be used in conjunction with the electronic device 1100, including but not limited to, microcode, device driver, redundant processing unit, external disk drive array, RAID system, tape driver and data backup storage system.

Through the description of the above embodiments, those skilled in the art can easily understand that the example embodiments described herein can be implemented by software, or can be implemented by software in combination with necessary hardware. Therefore, the technical solution according to the embodiments of the present disclosure may be embodied in the form of a software product, which may be stored in a non-transitory storage medium (e.g., CD-ROM, U disk, mobile hard disk, etc.) or on a network, and may include several instructions to cause a computing device (e.g., personal computer, server, mobile terminal, or network device, etc.) to perform the method according to the embodiments of the present disclosure.

In addition, the above-mentioned drawings are only schematic illustrations of processes included in the method according to the exemplary embodiment of the present invention, and are not intended to limit the purpose. It is easy to understand that the processes shown in the above drawings do not indicate or limit the chronological order of these processes. In addition, it is also easy to understand that these processes may be performed, for example, synchronously or asynchronously in multiple modules.

It should be noticed that, although several modules or units of apparatus for action execution are mentioned in the detailed description above, such division is not mandatory. Indeed, according to embodiments of the present disclosure, the features and functions of two or more modules or units described above may be embodied in one circuit or unit. Conversely, the features and functions of one of the modules or units described above may be further divided into a plurality of modules or units to embody.

Those skilled in the art will readily contemplate other embodiments of the present disclosure taking into consideration the specification and practicing the invention disclosed herein. The present application is intended to cover any variations, uses, or adaptations of this disclosure that conform to the general principles of this disclosure and include the common general knowledge or conventional technical means in the technical field not disclosed by this disclosure. The specification and examples are intended to be considered as exemplary only, and the protection scope and spirit of the disclosure are indicated by the following claims.

It should be understood that the present disclosure is not limited to the precise structure that has been described above and shown in the drawings, and that various modifications and changes can be made without departing from the scope thereof. The scope of the present disclosure is limited only by the appended claims.

1. An item processing method, comprising:
determining standard size information of items according to a standard size mapping relationship table;
collecting item purchase information of a user, and extracting standard sizes corresponding to the items from the item purchase information as a set of target standard size;
determining user preference size information from the set of target standard size according to purchase time of the items; and
querying an item corresponding to the user preference size information, and outputting the item corresponding to the user preference size information as item to be presented and/or preferentially presenting the item corresponding to the user preference size information.

2. The item processing method according to claim 1, wherein the determining user preference size information from the set of target standard size according to purchase time of the items comprises:
sorting the purchase time of items in reverse chronological order;
configuring weights for respective target standard sizes according to result sorted by the reverse chronological order; and
determining user preference size information based on the configured weights.

3. The item processing method according to claim 2, wherein the configuring weights for respective target standard sizes according to result sorted by the reverse chronological order comprises:
configuring weights for respective target standard sizes according to result sorted by the reverse chronological order in an exponential decay manner.

4. The item processing method according to claim 2, wherein the determining user preference size information based on the configured weights comprises:
calculating preference probabilities of information about respective target standard sizes based on the configured weights;
if a difference between a highest probability and a second-highest probability in calculated preference probabilities is greater than a threshold, determining the information of target standard size corresponding to the highest probability as the user preference size information; and
if the difference between the highest probability and the second-highest probability in calculated preference probabilities is not greater than the threshold, determining the information of target standard size corresponding to the highest probability and the information of target standard size corresponding to the second-highest probability as user preference size information.

5. The item processing method according to claim 4, wherein the preferentially presenting the items corresponding to the user preference size information comprises:
if size information of an candidate item matches the user preference size information, configuring weight for the candidate item; and
determining the candidate item having configured weight as the item to be presented preferentially and presenting it.

6. The item processing method according to claim 1, wherein after determining standard size information of items according to the standard size mapping relationship table, the item processing method further comprises:
storing the standard size information into a forward index of corresponding one of the items.

7-12. (canceled)

13. A storage medium having computer instructions stored thereon, wherein, when the computer instructions are executed by a processor, an item processing method is implemented, the method comprising:
determining standard size information of items according to a standard size mapping relationship table;
collecting item purchase information of a user and extracting standard sizes corresponding to the items from the item purchase information as a set of target standard size;
determining user preference size information from the set of target standard size according to purchase time of the items; and
querying an item corresponding to the user preference size information, and outputting the item corresponding to the user preference size information as item to be presented and/or preferentially presenting the item corresponding to the user preference size information.

14. An electronic equipment, wherein, comprising:
a processor; and
a memory for storing instructions executable by the processor;
wherein the processor is configured to:
determine standard size information of items according to a standard size mapping relationship table;
collect item purchase information of a user, and extract standard sizes corresponding to the items from the item purchase information as a set of target standard size;
determine user preference size information from the set of target standard size according to purchase time of the items; and
query an item corresponding to the user preference size information, and output the item corresponding to the user preference size information as item to be presented and/or preferentially present the item corresponding to the user preference size information.

15. The electronic equipment according to claim 14, wherein the processor is further configured to:
sort the purchase time of items in reverse chronological order;
configure weights for respective target standard sizes according to result sorted by the reverse chronological order; and
determine user preference size information based on the configured weights.

16. The electronic equipment according to claim 15, wherein the processor is further configured to:
configure weights for respective target standard sizes according to result sorted by the reverse chronological order in an exponential decay manner.

17. The electronic equipment according to claim 15, wherein the processor is further configured to:
calculate preference probabilities of information about respective target standard sizes based on the configured weights;
if a difference between a highest probability and a second-highest probability in calculated preference probabilities is greater than a threshold, determine the information of target standard size corresponding to the highest probability as the user preference size information; and
if the difference between the highest probability and the second-highest probability in calculated preference probabilities is not greater than the threshold, determine the information of target standard size corresponding to the highest probability and the information of target standard size corresponding to the second-highest probability as user preference size information.

18. The electronic equipment according to claim 16, wherein the processor is further configured to:
calculate preference probabilities of information about respective target standard sizes based on the configured weights;
if a difference between a highest probability and a second-highest probability in calculated preference probabilities is greater than a threshold, determine the information of target standard size corresponding to the highest probability as the user preference size information; and
if the difference between the highest probability and the second-highest probability in calculated preference probabilities is not greater than the threshold, determine the information of target standard size corresponding to the highest probability and the information of target standard size corresponding to the second-highest probability as user preference size information.

19. The electronic equipment according to claim 17, wherein the processor is further configured to:
if size information of an candidate item matches the user preference size information, configure weight for the candidate item; and
determine the candidate item having configured weight as the item to be presented preferentially and present it.

20. The electronic equipment according to claim 18, wherein the processor is further configured to:
if size information of an candidate item matches the user preference size information, configure weight for the candidate item; and
determine the candidate item having configured weight as the item to be presented preferentially and present it.

21. The electronic equipment according to claim 14, wherein the processor is further configured to:
store the standard size information into a forward index of corresponding one of the items.

22. The item processing method according to claim 3, wherein the determining user preference size information based on the configured weights comprises:
calculating preference probabilities of information about respective target standard sizes based on the configured weights;
if a difference between a highest probability and a second-highest probability in calculated preference probabilities is greater than a threshold, determining the information of target standard size corresponding to the highest probability as the user preference size information; and
if the difference between the highest probability and the second-highest probability in calculated preference probabilities is not greater than the threshold, determining the information of target standard size corresponding to the highest probability and the information of target standard size corresponding to the second-highest probability as user preference size information.

23. The item processing method according to claim 22, wherein the preferentially presenting the items corresponding to the user preference size information comprises:
if size information of an candidate item matches the user preference size information, configuring weight for the candidate item; and
determining the candidate item having configured weight as the item to be presented preferentially and presenting it.
